(19) United States
(12) Patent Application Publication
(10) Pub. No.: US 2015/0112719 A1
(43) Pub. Date: Apr. 23, 2015

(54) INFORMATION PROCESSING APPARATUS, INFORMATION PROCESSING METHOD, AND COMPUTER READABLE MEDIUM

(71) Applicant: FUJI XEROX CO., LTD., Tokyo (JP)

(72) Inventors: Masahiro IWATA, Kanagawa (JP); Toshio KUROGANE, Kanagawa (JP); Jun ANDO, Kanagawa (JP)

(73) Assignee: FUJI XEROX CO., LTD., Tokyo (JP)

(21) Appl. No.: 14/260,521

(22) Filed: Apr. 24, 2014

(30) Foreign Application Priority Data
Oct. 22, 2013 (JP) 2013-219234

(51) Int. Cl. G06F 19/00

(52) U.S. Cl. CPC G06F 19/322
USPC 705/3

(57) ABSTRACT

An information processing apparatus includes a document image obtaining unit, an attribute information obtaining unit, and a document-with-coded-image generating unit. The document image obtaining unit obtains a document image by scanning a document arranged in a specific format. The attribute information obtaining unit obtains attribute information on the document from character information written in a location specified based on the format of the document. The document-with-coded-image generating unit generates a document with coded image including a coded image based on the attribute information and document information that indicates contents of the document.

### CROSS-REFERENCE TO RELATED APPLICATIONS

This application is based on and claims priority under 35 USC 119 from Japanese Patent Application No. 2013-219234 filed Oct. 22, 2013.

### BACKGROUND

(i) Technical Field

The present invention relates to an information processing apparatus, an information processing method, and a computer readable medium.

(ii) Related Art

In an existing method, a coded image of attribute information may not be assigned to a document that has not been assigned with attribute information in advance. Therefore, such a document may not be applied to a document management system using coded information.

### SUMMARY

According to an aspect of the invention, there is provided an information processing apparatus including a document image obtaining unit, an attribute information obtaining unit, and a document-with-coded-image generating unit. The document image obtaining unit obtains a document image by scanning a document arranged in a specific format. The attribute information obtaining unit obtains attribute information on the document from character information written in a location specified based on the format of the document. The document-with-coded-image generating unit generates a document with coded image including a coded image based on the attribute information and document information that indicates contents of the document.

### BRIEF DESCRIPTION OF THE DRAWINGS

Exemplary embodiments of the present invention will be described in detail based on the following figures, wherein:

FIG. 1 is a diagram illustrating an example of a configuration of a document management system according to an exemplary embodiment of the invention;

FIG. 2 is a diagram illustrating an example of format data used in an electronic medical chart according to the exemplary embodiment;

FIG. 3 is a block diagram illustrating an example of functions to be executed by an image processing apparatus according to the exemplary embodiment;

FIG. 4 is a flowchart illustrating an example of a flow of a document management processing to be executed by the image processing apparatus according to the exemplary embodiment;

FIG. 5 is a diagram illustrating an example of a document to be scanned by an image reading unit according to the exemplary embodiment; and

FIG. 6 is a diagram illustrating an example of a document with coded image according to the exemplary embodiment.

### DETAILED DESCRIPTION

An exemplary embodiment of the present invention will be hereinafter described with reference to the attached drawings. In the exemplary embodiment, an example of an information processing apparatus will be described with an example of an image processing apparatus. However, the information processing apparatus may be of a different type.

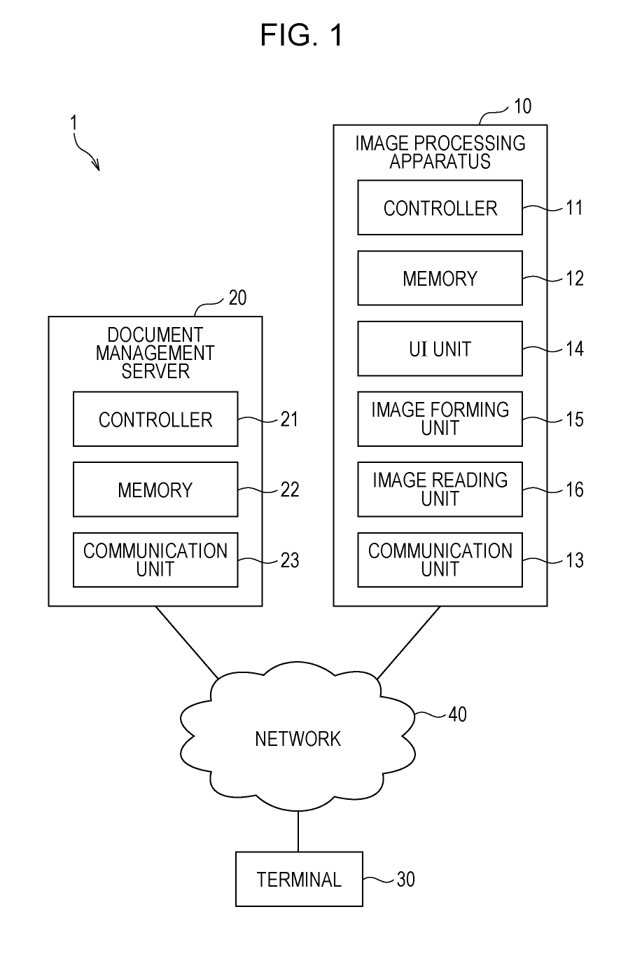

FIG. 1 is a diagram illustrating an example of a configuration of a document management system 1 according to an exemplary embodiment of the invention. As illustrated in FIG. 1, the document management system 1 includes an image processing apparatus 10, a document management server 20, and a terminal 30. In the exemplary embodiment, the image processing apparatus 10, the document management server 20, and the terminal 30 are each connected to a network 40, and are capable of data communication with each other.

The image processing apparatus 10 is, for example, a multifunction apparatus (an apparatus that includes multiple functions such as a printer, a photocopier, a scanner, and a facsimile machine) or the like, and as illustrated in FIG. 1, includes a controller 11, a memory 12, a communication unit 13, a user interface (UI) unit 14, an image forming unit 15, and an image reading unit 16.

The controller 11 is a central processing unit (CPU) or the like, and executes various types of information processing in accordance with a program stored in the memory 12. A specific example of processing performed by the controller 11 will be described later.

The memory 12 includes memory elements, such as a random access memory (RAM) and a read only memory (ROM), a hard disk, and the like. The memory 12 holds programs executed by the controller 11 and various data. Furthermore, the memory 12 also operates as a work memory of the controller 11.

The communication unit 13 is a network interface, such as a LAN card, and enables transmission and reception of information between information processing apparatuses, such as the document management server 20, the image processing apparatus 10, and the terminal 30, via a communication section.

The UI unit 14 includes a touch panel, a liquid crystal display, an input device (for example, a keyboard, a touch pad, or the like), and the like. The UI unit 14 displays, for example, a menu screen or the like for prompting a user to input an instruction in accordance with an instruction input from the controller 11. Furthermore, the UI unit 14 receives an instruction input from the user, and outputs information which indicates the contents of the instruction to the controller 11.

The image forming unit 15 includes a printer engine for a laser printer, an inkjet printer, or the like, and in accordance with an instruction from the controller 11, executes print processing to form an image on a medium such as paper. With the image forming unit 15, the image processing apparatus 10 functions as an image forming apparatus. Furthermore, the image reading unit 16 is an image scanner or the like. The image reading unit 16 reads an image formed on a medium such as paper, and executes scan processing to output data which represents the image.

The document management server 20 is, for example, a server computer or the like, and as illustrated in FIG. 1, includes a controller 21, a memory 22, and a communication unit 23. The document management server 20 holds various document data in the memory 22, and following a processing execution request (access request) by a user, executes various types of processing for the document data. Document data to be managed by the document management server 20 may be electronic data or scanned images including various types of content as well as text. The controller 21, the memory 22, and the communication unit 23 may have the same configurations as the controller 11, the memory 12, and the communication unit 13, respectively.

The terminal 30 is, for example, a personal computer or the like, and includes a controller which is a program controlling device, such as a CPU, which operates in accordance with a program installed in the terminal 30; a memory which includes memory elements, such as a ROM and a RAM, a hard disk drive, and the like; a communication unit which is a communication interface, such as a network board; a display unit, such as a display; and an operation unit, such as a mouse, a keyboard, and a button.

Information managed by the document management server 20 in the exemplary embodiment will be described below. Document data generated by scanning documents with the image reading unit 16 of the image processing apparatus 10, document data generated by the terminal 30, and the like are accumulated in the document management server 20, and the document management server 20 manages the accumulated document data. In the exemplary embodiment, the document management server 20 is described as a server which manages electronic medical charts as document data. However, the exemplary embodiment is not limited to this, and document data may be various different document data. Attribute information related to an electronic medical chart (such as a patient code, a name, an injury/sickness name, and a date) is associated with the electronic medical chart. With this association, an electronic medical chart including a specific attribute may be searched for using attribute information. Furthermore, it is assumed that a paper medical chart with the same contents listed as in an electronic medical chart is also physically managed. A coded image (such as a barcode or a QR code®) on which attribute information is coded is assigned to a paper medical chart, and the attribute information is able to be obtained by reading the coded image.

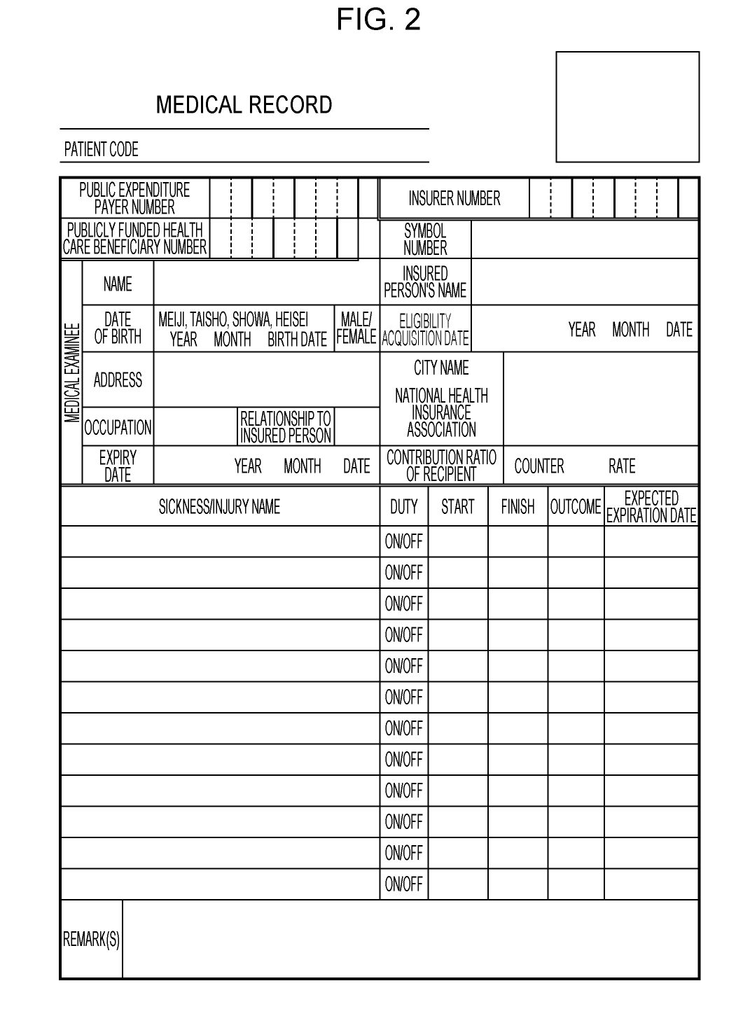

In the exemplary embodiment, it is assumed that an electronic medical chart is created based on a specific format and that multiple types of format data used on the electronic medical chart are registered on the memory 22 of the document management server 20. FIG. 2 is a diagram illustrating an example of format data used for an electronic medical chart according to the exemplary embodiment. As illustrated in FIG. 2, format data (here, a medical record) used for an electronic medical chart includes columns in which patient information, such as a patient code and an injury/sickness name, are to be entered. The terminal 30 creates an electronic medical chart of a medical record by obtaining the medical record from the memory 22 of the document management server 20 in accordance with an operation by a user and inputting patient information in individual columns. Then, the terminal 30 obtains at least one of plural pieces of the patient information input in the individual columns of the medical record as attribute information of the medical record, associates the attribute information with the electronic medical chart of the medical record, and then stores the attribute information along with the electronic medical chart of the medical record in the memory 22 of the document management server 20. As described above, the electronic medical chart is managed in the document management server 20 along with the attribute information.

Not only electronic medical charts created as described above, but hand-written medical charts, medical charts created before introduction of electronic medical charts, and medical charts using format data which is not registered, are also able to be managed in association with attribute information by the document management server 20. Details of the management by the document management server 20 will be described below.

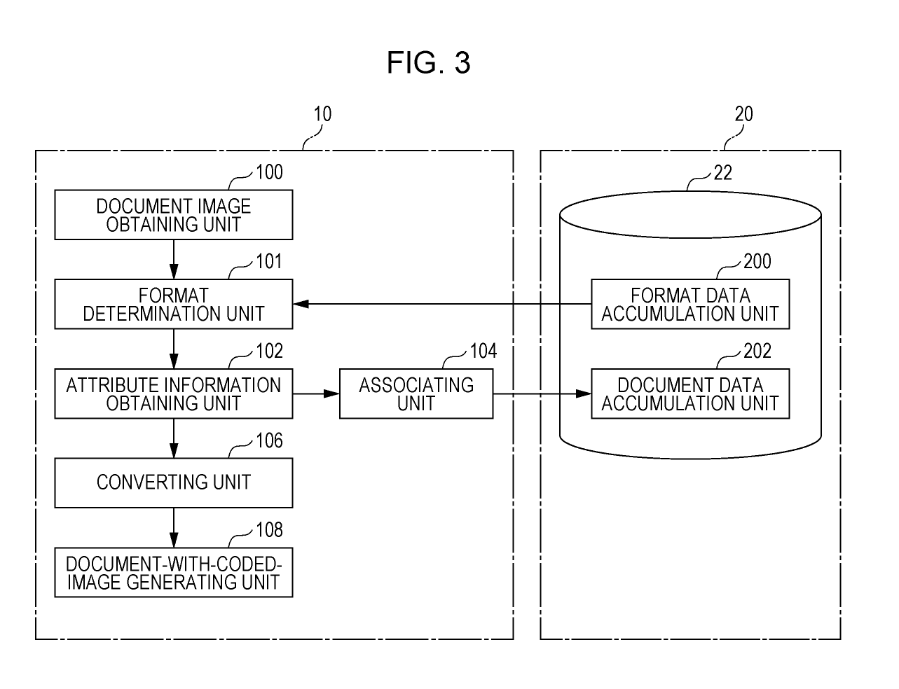

FIG. 3 is a block diagram illustrating an example of functions to be executed by the image processing apparatus 10 according to the exemplary embodiment. As illustrated in FIG. 3, the controller 11 of the image processing apparatus 10 includes a document image obtaining unit 100, a format determination unit 101, an attribute information obtaining unit 102, an associating unit 104, a converting unit 106, and a document-with-coded-image generating unit 108. In the image processing apparatus 10 according to the exemplary embodiment, functions other than the functions illustrated in FIG. 3 may be implemented. These functions are implemented when a program stored in the memory 12 executes the controller 11. The program is supplied to the image processing apparatus 10 via a computer-readable information storing medium, such as an optical disk, a magnetic disk, a magnetic tape, an optical magnetic disk, or a flash memory stick, or via a communication section, such as the Internet.

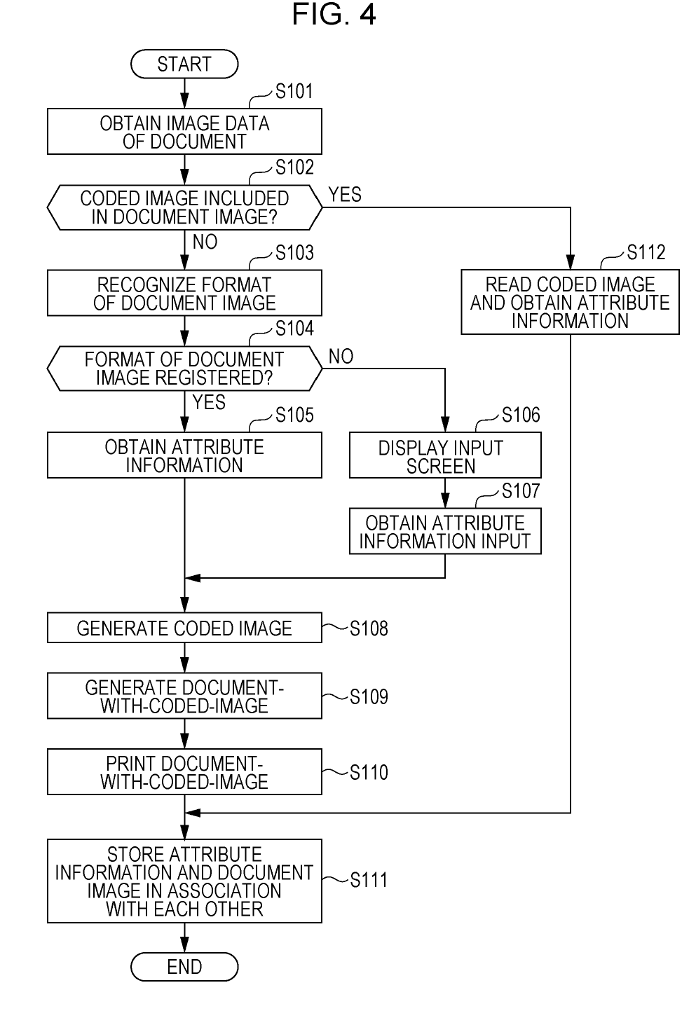

An example of a flow of a document management process to be executed by the image processing apparatus 10 in the exemplary embodiment will be described with reference to the flowchart of FIG. 4.

The document image obtaining unit 100 obtains image data of a document scanned with the image reading unit 16 (S101). The document may be various paper medical charts, x-ray images, or the like, and information input by handwriting or by data is included on the document.

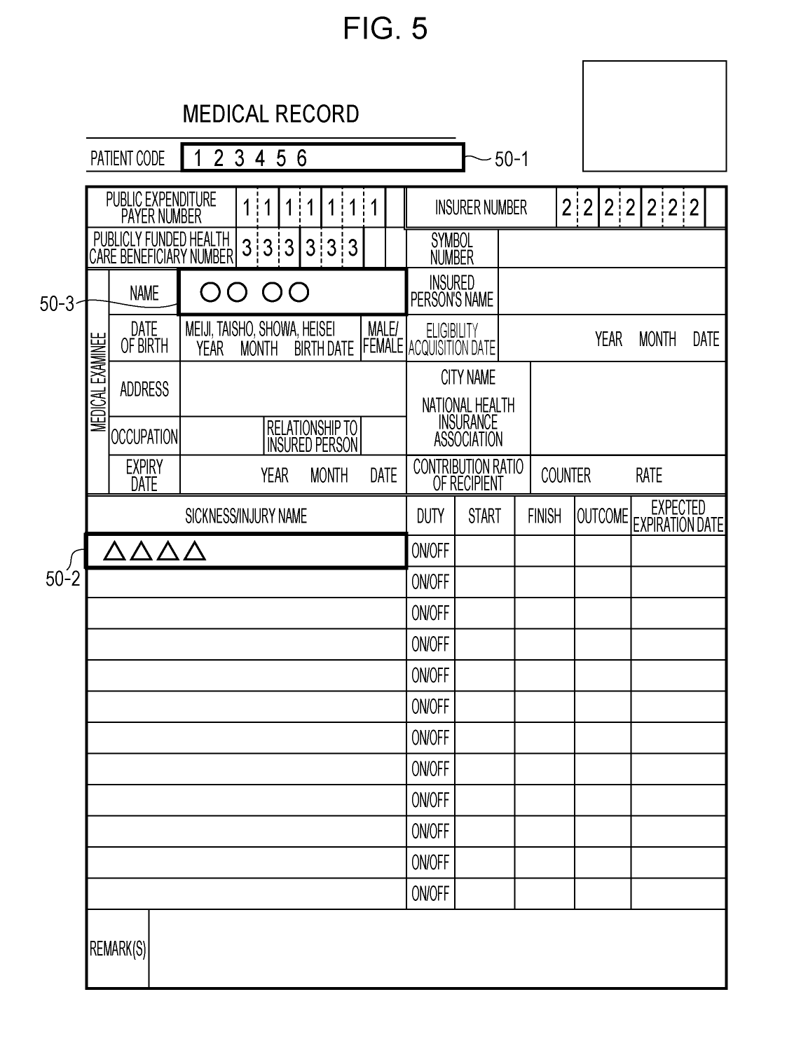

FIG. 5 is a diagram illustrating an example of a document to be scanned with the image reading unit 16. As illustrated in FIG. 5, as a document to be scanned with the image reading unit 16, format data (here, a medical record) used in the electronic medical chart illustrated in FIG. 2 is used, and the patient information is entered in individual columns of the document.

The document image obtaining unit 100 determines whether or not a coded image is included in the document image obtained (S102).

In the case where it has been determined in S102 that a coded image is not included in the document image obtained, the format determination unit 101 recognizes the format of the document image obtained by the document image obtaining unit 100 (S103), and determines whether or not format data that matches the recognized format is registered in a format data accumulation unit 200 of the document management server 20 (S104).

In the case where it has been determined in S104 that format data that matches the format of the document image is registered in the format data accumulation unit 200 of the document management server 20, the attribute information obtaining unit 102 obtains attribute information by performing character recognition for an entry area of the attribute information specified based on the format of the document image obtained by the document image obtaining unit 100 (S105).

As illustrated in FIG. 5, it is assumed that, for example, entry areas 50-1 and 50-2 are specified as entry areas (50-1 to 50-n) of attribute information for format data of a medical record, and character recognition is performed for the entry areas 50-1 and 50-2. Here, as character recognition, a known pattern matching method is used. However, a different method may be used. More specifically, a standard pattern for a character to be recognized is stored in the memory 22 of the document management server 20, a pattern of a character entered is matched against the standard pattern stored in the memory 22, and a character code corresponding to the standard pattern with the highest degree of matching is obtained as a recognition result. In the exemplary embodiment, candidates for a patient code, an injury/sickness name, and the like, which serve as patient information, may be preregistered as standard patterns. Furthermore, in the case where the attribute information obtaining unit 102 does not recognize attribute information by character recognition, the attribute information may be specified by performing character recognition for a different entry area. For example, in the case where characters entered in the entry area 50-1 (patient code) and the entry area 50-2 (injury/sickness name) illustrated in FIG. 5 are not recognized, the attribute information obtaining unit 102 performs character recognition for an entry area 50-3 (name), and specifies the patient code and the injury/sickness name in accordance with the name information obtained. Alternatively, the attribute information obtaining unit 102 performs character recognition for the entry area 50-3 (name), and uses the obtained name information as attribute information. In the case where the attribute information obtaining unit 102 does not recognize attribute information by character recognition, candidates for a preregistered standard pattern may be indicated, so that a user may be able to select one of the candidates.

In the case where it has been determined in S104 that format data which matches the format of the document image is not registered in the format data accumulation unit 200 of the document management server 20, the UI unit 14 displays an input screen for attribute information (S106). The input screen may be a screen on which the user manually inputs attribute information or on which candidates of attribute information which are preregistered in the memory 22 of the document management server 20 are displayed so that the user selects amongst the displayed candidates. Then, the attribute information obtaining unit 102 obtains the information input by the user as the attribute information (S107).

A patient database, which is not illustrated, may be referred to in order to verify the accuracy of the attribute information obtained by the attribute information obtaining unit 102 in S105 or S107. More specifically, for example, when the attribute information obtained by the attribute information obtaining unit 102 is a patient code and an injury/sickness name, it may be verified whether a patient corresponding to the patient code and a medical department corresponding to the injury/sickness name exist. Furthermore, it may also be verified whether the medical department in which the patient corresponding to the patient code is examined corresponds to the injury/sickness name obtained. That is, it may be verified whether the multiple pieces of attribute information obtained by the attribute information obtaining unit 102 correspond to each other.

Furthermore, the user may verify information obtained through character recognition of a different entry area. For example, the attribute information obtaining unit 102 performs character recognition for the entry area 50-3 (name) illustrated in FIG. 5, and the UI unit 14 displays the name information obtained through the character recognition. Then, the user sees the name information and verifies that a person specified by the name information is a desired patient. Furthermore, the attribute information obtaining unit 102 may determine whether the name information obtained through the character recognition for the entry area 50-3 matches the patient information corresponding to the patient code.

Next, the converting unit 106 generates a coded image to be printed on a paper medium as a code in a machine readable form, such as a barcode or a QR code®, based on the attribute information obtained by the attribute information obtaining unit 102 (S108).

The document-with-coded-image generating unit 108 generates a document with coded image by overlapping the coded image generated by the converting unit 106 and the document image obtained by the document image obtaining unit 100 (S109), and the image forming unit 15 then prints the document with coded image on the paper medium (S110). Here, the document-with-coded-image generating unit 108 determines an area in which the coded image is to be overlapped based on the format of the document image recognized by the format determination unit 101. More specifically, the document- with-coded-image generating unit 108 searches for a blank area outside the entry areas, in the format of the document image recognized by the format determination unit 101. Furthermore, when registering format data used in the electronic medical chart in the memory 22 of the document management server 20, an area optimal for overlapping a coded image may be specified for each format data, and location information of the area may be registered in association with the format data. Then, the coded image is overlapped in the area based on the location information associated with the format data recognized by the format determination unit 101. On the document scanned with the image reading unit 16 in S101, the coded image generated by the converting unit 106 may be printed and the resultant document may be regarded as a document with coded image.

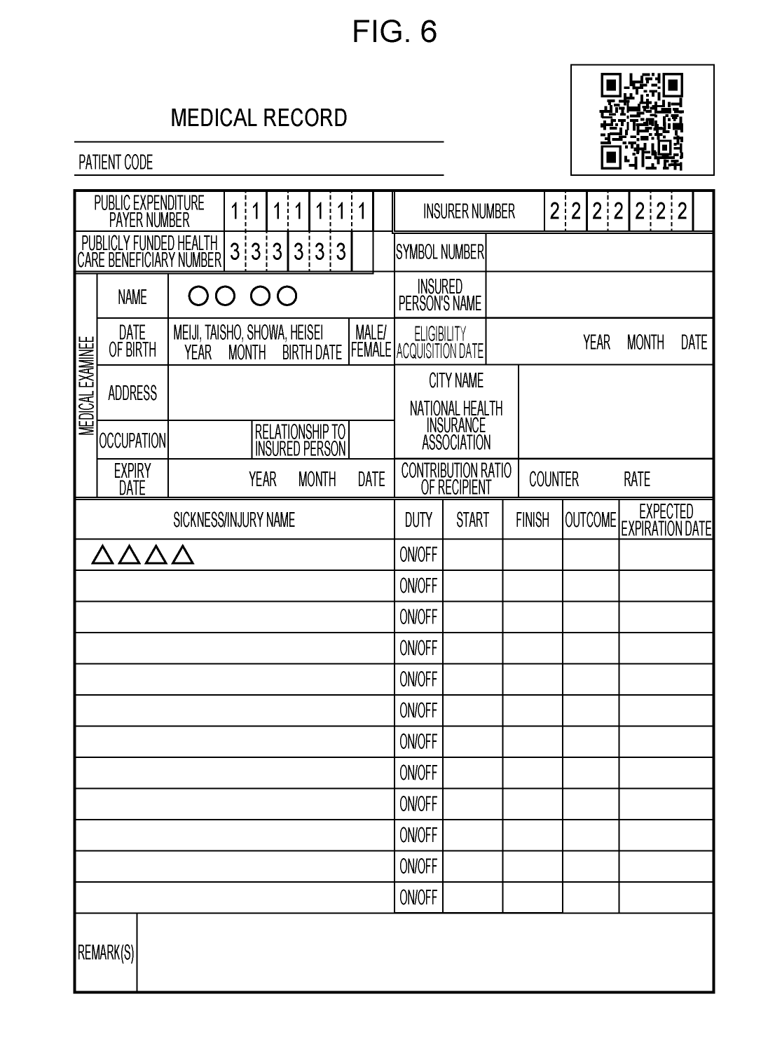

FIG. 6 is a diagram illustrating an example of a document with coded image. As illustrated in FIG. 6, the document with coded image includes a coded image in the blank area of the document illustrated in FIG. 5. The document with coded image in which a coded image is printed as illustrated is managed as a paper medical chart.

The associating unit 104 associates the document image obtained by the document image obtaining unit 100 with the attribute information obtained by the attribute information obtaining unit 102, and stores the document image and the attribute information that are in association with each other in a document data accumulation unit 202 of the document management server 20 (S111). Then, the document management process ends. The associating unit 104 may also associate the document-with-coded-image generated by the document-with-coded-image generating unit 108 with the attribute information obtained by the attribute information obtaining unit 102 and store the document with and the attribute information that are in association with each other in the document data accumulation unit 202 of the document management server 20.

Furthermore, in the case where it has been determined in S102 that a coded image is included in the document image obtained, the attribute information obtaining unit 102 obtains attribute information by reading the coded image with the image reading unit 16 (S112). Then, the associating unit 104 associates the document image obtained by the document image obtaining unit 100 with the attribute information obtained by the attribute information obtaining unit 102, and stores the document image and the attribute information that are in association with each other in the document data accumulation unit 202 of the document management server 20 (S111). Then, the document management process ends.

The invention is not intended to be limited to the exemplary embodiment described above.

In the case where the document image obtaining unit 100 obtains image data of the document scanned with the image reading unit 16 in S101, the image reading unit 16 may scan multiple documents continuously. A related document which relates to a certain document is scanned continuing to the document, and in the case where it has been determined in S104 that format data which matches the format recognized from the document image is not registered in the format data accumulation unit 200 of the document management server 20, it is determined that the document image is a related document image. That is, it is determined that the document image is a related document image which relates to the document image for which it has been determined in S104, just before, that format data which matches the recognized format is registered in the format data accumulation unit 200 of the document management server 20. Then, the attribute information obtained from the document image related to the related document image and the attribute information indicating that the document is a related document are associated with each other on the related document image.

Furthermore, even in the case where it has been determined in S102 that a coded image is included in the document image obtained, the attribute information may be changed (for example, addition of injury/sickness name, or the like). In such a case, the image processing apparatus 10 performs scanning after performing setting so that the attribute information may be changed, and changes the attribute information read from the coded image to new attribute information. Then, the converting unit 106 converts the changed attribute information to a coded image, and the document-with-coded-image generating unit 108 generates a document with coded image in which the originally assigned coded image is replaced with the coded image of the changed attribute information. Furthermore, the associating unit 104 may associate the changed attribute information with a scanned document-image-with-coded-image, and store the attribute information and the document image that are in association with each other in the document data accumulation unit 202 of the document management server 20. Alternatively, the associating unit 104 may associate the changed attribute information with a document image in which an assigned coded image has been deleted from a scanned document-image-with-coded-image, and store the attribute information and the document image that are in association with each other in the document data accumulation unit 202 of the document management server 20.

Furthermore, by displaying the preview of the image of the document scanned with the image reading unit 16 on the UI unit 14, it may be made possible for the user to verify the contents of the scanned document. In that instance, it may also be made possible for the user to verify that there are no errors in the contents by displaying the attribute information obtained by the attribute information obtaining unit 102 along with the image of the scanned document on the UI unit 14.

In the exemplary embodiments, the processing executed by the controller of the image processing apparatus may also be executed by a different information processing apparatuses, such as the document management server.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a document image obtaining unit that obtains a document image by scanning a document arranged in a specific format;
an attribute information obtaining unit that obtains attribute information of the document from character information written in a location specified based on the format of the document; and
a document-with-coded-image generating unit that generates a document with coded image including a coded image based on the attribute information and document information that indicates contents of the document.

2. The information processing apparatus according to claim 1, wherein the document-with-coded-image generating unit overlaps the coded image in an area specified based on the format of the document.

3. The information processing apparatus according to claim 1, further comprising:
a document-image-with-coded-image obtaining unit that obtains a document-image-with-coded-image by scanning the document with coded image;
a coded image reading unit that reads the coded image included in the document with coded image; and
an associating unit that associates the attribute information obtained by reading the coded image with document-information-with-coded-image that indicates contents of the document with coded image.

4. The information processing apparatus according to claim 2, further comprising:
a document-image-with-coded-image obtaining unit that obtains a document-image-with-coded-image by scanning the document with coded image;
a coded image reading unit that reads the coded image included in the document with coded image; and
an associating unit that associates the attribute information obtained by reading the coded image with document-information-with-coded-image that indicates contents of the document with coded image.

5. The information processing apparatus according to claim 1, wherein:
the document image obtaining unit obtains a related document image by scanning a related document relating to the document following the scanning of the document; and
the document-with-coded-image generating unit generates the document with coded image including the coded image based on the attribute information and the document information, and a related document with coded image including the coded image based on the attribute information and related document information that indicates contents of the related document.

6. The information processing apparatus according to claim 2, wherein:
the document image obtaining unit obtains a related document image by scanning a related document relating to the document following the scanning of the document; and
the document-with-coded-image generating unit generates the document with coded image including the coded image based on the attribute information and the document information, and a related document with coded image including the coded image based on the attribute information and related document information that indicates contents of the related document.

7. The information processing apparatus according to claim 3, wherein:
the document image obtaining unit obtains a related document image by scanning a related document relating to the document following the scanning of the document; and
the document-with-coded-image generating unit generates the document with coded image including the coded image based on the attribute information and the document information, and a related document with coded image including the coded image based on the attribute information and related document information that indicates contents of the related document.

8. The information processing apparatus according to claim 4, wherein:
the document image obtaining unit obtains a related document image by scanning a related document relating to the document following the scanning of the document; and
the document-with-coded-image generating unit generates the document with coded image including the coded image based on the attribute information and the document information, and a related document with coded image including the coded image based on the attribute information and related document information that indicates contents of the related document.

9. An information processing method comprising:
obtaining a document image by scanning a document arranged in a specific format;
obtaining attribute information of the document from character information written in a location specified based on the format of the document; and
generating a document with coded image including a coded image based on the attribute information and document information that indicates contents of the document.

10. A non-transitory computer readable medium storing a program causing a computer to execute a process for information processing, the process comprising:
obtaining a document image by scanning a document arranged in a specific format;
obtaining attribute information of the document from character information written in a location specified based on the format of the document; and
generating a document with coded image including a coded image based on the attribute information and document information that indicates contents of the document.
